(19) United States
(12) Patent Application Publication
(10) Pub. No.: US 2006/0249649 A1
(43) Pub. Date: Nov. 9, 2006

(54) Industrial Workbench with Digital Input, Output, Processing, and Connectivity Devices

(76) Inventors: Russell L. Volk, Peterson, UT (US); Doretta E. Gordon, Layton, UT (US)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/279,346

(22) Filed: Apr. 11, 2006

Related U.S. Application Data
(60) Provisional application No. 60/670,141, filed on Apr. 11, 2005.

(51) Int. Cl. B25H 1/00

(52) U.S. Cl. 248/917; 144/286.5

(57) ABSTRACT

A “digital workbench”, especially designed for the data needs of an industrial plant or shop. The workbench incorporates two monitors, a CPU, and various input and output devices, including a camera, which may be used to capture work activities.

### CROSS-REFERENCE TO RELATED APPLICATIONS

This application claims the benefit of U.S. Provisional Application No. 60/670,141 filed on Apr. 11, 2005, entitled “Industrial Workbench with Digital Input, Output, Processing, and Connectivity Devices”, which is incorporated herein by reference in its entirety.

### TECHNICAL FIELD OF THE INVENTION

This invention relates to industrial equipment, and more particularly to a workbench having digital input, output, processing and connectivity devices.

### BACKGROUND OF THE INVENTION

With the advance of the “digital age” and the proliferation of digital data, work areas that have been previously less affected, such as industrial plants, will require workers to access and manipulate data at their workstations. Yet conventional computer workstations are not suitable for industrial environments.

Within many industrial environments, technical data required to perform certain work, such as repair and design, is rapidly moving to a digital format. However, a lack of access to computers limits the use of digital data.

Current approaches to technical data availability have focused on adding technology (e.g., computers and monitors) to existing workbenches. However, workspace is often at a premium, and space for the addition of traditional computer-based technologies is limited. Space on a workbench is often consumed by tools, test equipment, and technical data used in the repair process, in addition to the actual component being repaired, inspected, or otherwise worked on.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a first embodiment of a digital processing workbench in accordance with the invention.

FIG. 2 illustrates a second embodiment of the digital workbench.

FIG. 3 illustrates the use of a camera and monitor with the workbench.

FIG. 4 illustrates an oscilloscope used with the workbench.

### DETAILED DESCRIPTION OF THE INVENTION

The following description is directed to a “digital processing workbench”, which implements a holistic approach to analyzing the work processes and resource requirements to be supported by digital technology. The workbench integrates digital data functionalities into a digital workspace especially suited for an industrial environment. It allows a worker to view digital data of varying sizes (e.g., schematics and blueprints) and formats (e.g., repair manuals and technical orders), while providing a sufficiently large workspace, as well as ease of use and durability.

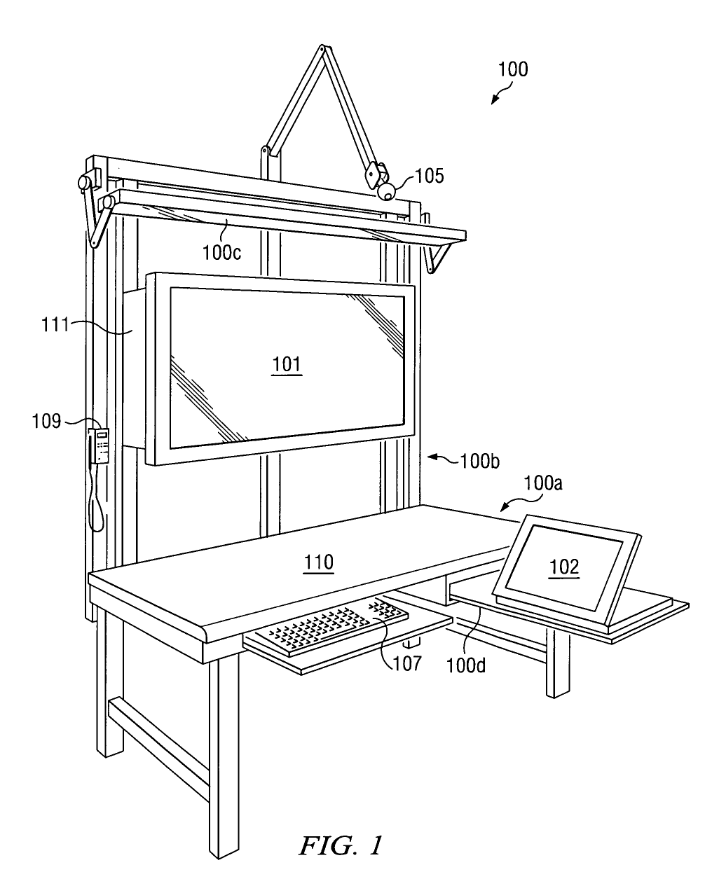

FIG. 1 illustrates a digital workbench 100 in accordance with the invention. As explained below, workbench 100 has integrated and embedded input, output, processing, and connectivity devices for the purpose of allowing workers in an industrial environment to access digital data at their workstations. Its design takes into account various industrial environmental constraints, such as usability, space limitations, ergonomics, visibility issues, chemical and electrical hazards, and functionality.

Workbench 100 has a heavy duty table 100a with a large flat work surface. A vertical mounting frame 100b is affixed to the back edge of table 100a, and as explained below provides means for mounting an adjustable overhead light 100c and a large monitor 101. Light 100c extends across the length of workbench 100 and it is attached to frame 100b in a manner that permits it to be moved up and down, thereby adjusting the height of the light source relative to the table surface. The tilt angle of light 100c may also be adjusted. One side of table 100a has a retractable platform or drawer 100d for holding a smaller monitor or computer 102, such as a tablet-type computer.

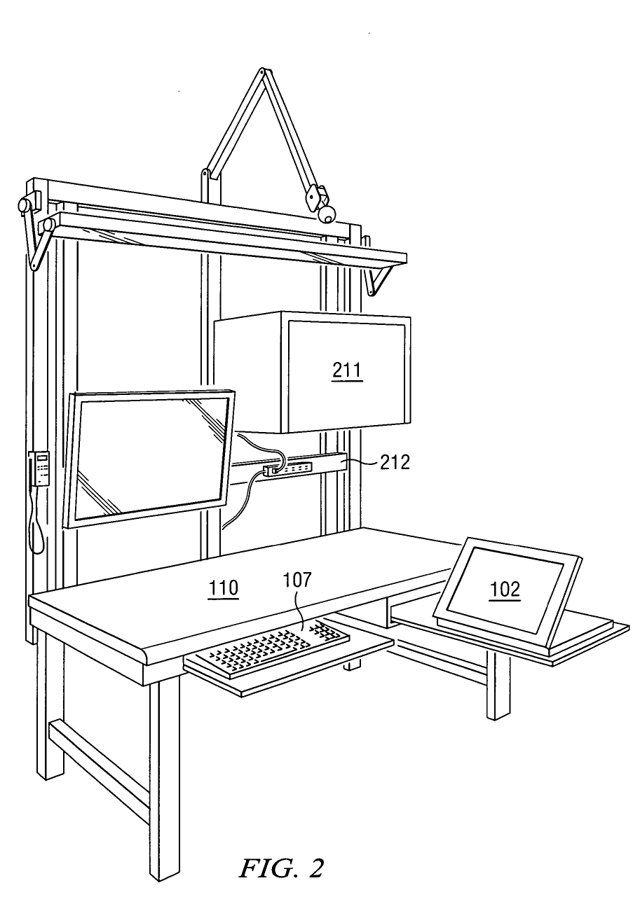

FIG. 2 illustrates workbench 100, but with a longer worksurface 110, and an overhead storage compartment 211 mounted next to monitor 101. Also, the keyboard 107 is housed in a drawer 211 incorporated into table 100a, as is monitor 102. Frame 100b has an electrical plug device 212 mounted for easy access.

Table 100a and mounting frame 100b are made from a strong rigid material, such as steel, wood, or composite material. Frame 100b may be made with means for adjusting the height and tilt of monitor 101.

Referring to both FIGS. 1 and 2, workbench 100 has a number of built-in devices: two display monitors 101 and 102, CPU 103, video camera 105, audio/vocal audio input/output device 106, wireless keyboard 107, wireless mouse 108, and bar code scanner 109.

The two display monitors 101 and 102 permit viewing of multiple digital files simultaneously, if desired. The dual monitor design allows greater flexibility for the technician for specific arrangement of displays to best suit the production environment.

The larger back panel monitor 101 will most likely be used for viewing larger items such as schematics and technical orders. An example of a suitable size for monitor 101 is 30″. It may be in front of a storage compartment 111, and flip up or slide to open the compartment.

The smaller monitor 102, stationed to the user's right or left, provides easy access to forms and the user's desktop. It is located at a convenient height and reach for the seated technician. Monitor 102 allows for maximum viewing space at reading level for such documents as technical orders or work control documents. An example of a suitable size for monitor 102 is 18″. If desired, a touchscreen type monitor may be used.

CPU 103 serves as the primary CPU for the workbench 100. It is not shown in FIG. 1, but in that embodiment, may be housed in a tower type box and mounted under table 100a. In FIG. 2, CPU 103 may be placed in storage compartment 210.

Video camera 105 is mounted on an adjustable articulated arm to allow for ease of manipulation during expert knowledge capture activities. The camera 105 can be used in conjunction with an audio headset (not shown) and collaboration software to allow for live dialogue relative to captured tacit knowledge. Additionally, video camera 105 can be used in conjunction with high-end optics and large monitor 101 to allow a technician to magnify the work for repair of fine detail areas.

Keyboard 107 may be a projection keyboard, as shown in FIG. 1. Alternatively, keyboard 107 may be a conventional key-type keyboard, wired or wireless, as shown in FIG. 2.

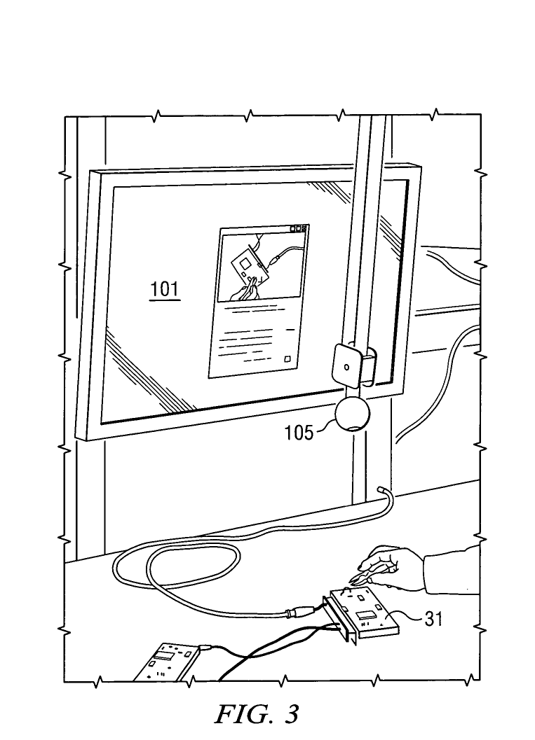

FIG. 3 illustrates the use of camera 105 with monitor 101 to capture a user's manipulation of a workpiece 31, shown in FIG. 3 as a circuit board. The data capture can be communicated to a remote audience or stored for purposes such as collaboration or training.

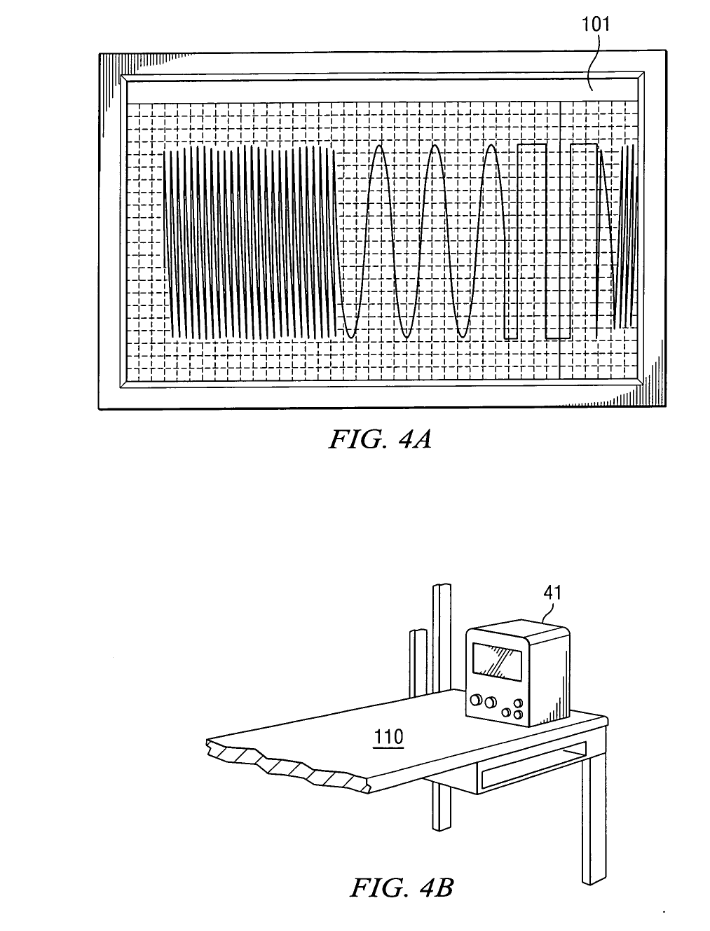

FIG. 4 illustrates how a DATAQ® oscilloscope application may be integrated into the workbench. An oscilloscope 41 is being used with the workpiece, with the output displayed on monitor 101. This is but one example of how integration of test equipment can expand the capabilities of the electronic workbench to include computerized displays of critical test readouts during the overhaul process of electronic components.

An example of a suitable monitor 101 is the Mitsubishi MLM300 monitor. Its specifications are:
True WXGA 1280×768 resolution
30″ wide monitor
DVI-D digital input
Weight: 44.1 lbs
Color: Over 16 million colors
Digital input signal (better resolution)

An example of a suitable monitor 102 is the WACOM Cintiq 18SX. Its specifications are:
Screen Size: 18.1″
Resolution: 1280×1024
Rotation ±180°
Pixel response time: 27 ms
Viewing Angle: 160°
Anti-glare, anti-reflective coating
   Its advantages are digital video input, versatility, durability, and large screen size.

An example of a suitable CPU 103 is the Gateway e-4100-c computer. Its specifications are:
OS: Microsoft® Windows® XP Professional Edition
Intel® Pentium® 4 Processor 3.2 GHz
Memory: 1 GB PC3200 DDR 400 MHz DDR
SDRAM (2-DIMMs)
40 GB ultra ATA100 7200 rpm hard drive
48×/32×/48× CD-RW/DVD combo drive
6-bay mid-tower case with front audio ports
250-watt power supply
External Ports: 8 USB 2.0 (2 in front and 6 in back); 1 Serial; 1 Parallel; 2 PS/2, 1 RJ-45
Integrated LAN; 1 VGA; 1 Microphone; front audio

An example of a suitable graphics card for CPU 103 is the Matrox Millennium graphics card. Its specifications are:
64 MB of DDR memory and AGP 8X support
2D, 3D and DVD-Video acceleration
2048×1536 Maximum screen resolution

One advantage is versatility, especially in the sense that it allows for dual video output.

Examples of a suitable mouse 108 and keyboard 107 are those available from Gateway Computers. As stated above, they may provide a wireless IR connection.

An example of a suitable bar code scanner 109 is the Intermec Sabre 1551 scanner. It has the following specifications:
Length: 8.9 cm
Height: 17.8 cm
Width: 5.6 cm
Weight: 185 g
Power: 215 mA
Scan Rate: 36±3 scans per second

In other embodiments, monitor 102 may be part of, or used with, a tablet PC or other device having its own processor, and housed in drawer lood. An example of a suitable tablet PC is the Kontron Revolution tablet PC. Its specifications are:
Intel Pentium M processor 735
BUS Speed: 400 MHz
L2 Cache: 2 MB
Memory: 512 MB
Operating System: Windows XP
Magnesium chassis
DVD/CD-RW Combo
Removable 60 GB Hard drive
Backlit sealed keyboard
Sealed mouse
   Its advantages are its durability; it is built to MIL standards. It is also versatile because of its built-in wireless antenna.

All of these functionalities, now integrated, completely support workload requirements within an industrial plant or shop. Integration of digital industrial workbenches 100 within production shops will increase efficiency by making more time available for production work. A rough estimate of current average time per eight hour day spent away from the workbench in conducting such tasks as entering time and attendance, completing digital forms, entering data on repaired assets, and locating technical data is well over one hour per person. By placing all needed resources within reach of the technician at workbench 100, a significant time savings can be realized. Digital industrial workbench 100 allows the technician to complete all their work task at their workstation without any required in-shop travel.

By introducing the digital workbench 100 to the production environment, increased effectiveness can be expected in three main areas: standardization of repair process, improvement of repair process by using expert knowledge, and improvement of testing capabilities.

In the current paper-based technical data paradigm, technicians tend to use outdated materials to conduct their repair process. This leads to incorrect repairs and forced rework. This problem will be eliminated by use of the digital workbench 100. Digital technical data may be “pushed” to the technician at their bench directly from the standard technical data repository.

Seasoned technicians within shops often figure out better ways to complete a repair process than those used in the past. This expertise is historically lost when these experts retire. By introducing expert knowledge capture and sharing through use of the digital workbench, process improvements can be made available at the point of need and pushed out to the workforce. Additionally, expert technicians can record their wisdom while they are repairing or testing an asset. By pulling the video camera 105 into place, putting on the headset, and clicking “capture video and audio,” the technician can describe and show his or her expert knowledge. This digital knowledge asset can then be saved and forwarded to a cognizant engineer for review and official acceptance into the technical data system. Or alternatively, the knowledge asset could be viewed live by other technicians or engineers locally or at other networked locations using standard communication applications.

A further effectiveness benefit from the introduction of the digital workbench 100 is the ability to integrate test equipment, such as the oscilloscope of FIG. 4. With computing capability on every bench, various types of test equipment which currently are stand-alone in nature, can now be integrated into the workbench 100. Various peripheral equipment can connect via a Universal Serial Bus (USB) port on the computer 103.

The ability to integrate stand-alone test equipment into the bench increases effectiveness in several ways. First, this allows for ease of upgrade of test equipment. Frequently, shops stay with outdated equipment because the cost to replace the equipment is very high. With the ability to break down the process the equipment encompasses and integrate it into a digital test station, a potential cost savings may be available. Calibration issues related to having stand alone test equipment which is frequently moved and jarred and in need of recalibration is also diminished or eliminated. Digital test equipment could be available on every digital workbench instead being limited by the number of physical stand alone testers available. Finally, integrating the test into the workbench frees up workspace for the technician to conduct the actual repair.

Another opportunity afforded by workbench 100 is the ability to integrate stand-alone test equipment with the computing capabilities of the bench. The potential impact of this opportunity is beneficial in three primary ways. First, incorporating the test equipment frees up space on the workbench for completing the actual repair. As shown in FIG. 1, the actual asset being repaired often takes up a large amount of the working space. Depending on the size and quantity of testers needed and the size of the technical data, little workspace is left for the technician to actually complete the work. Secondly, the large flat panel monitor 101 can be used to provide a display that is easier for the technician to view. For example, rather than a 5.5″ (diagonal) screen used on a standard oscilloscope, the oscilloscope waveforms can be displayed on a full 30″ screen or a portion of it. A third benefit is potential cost savings. Stand-alone test equipment is often expensive. For instruments requiring their own displays (e.g., oscilloscopes, logic analyzers) and microprocessors, utilizing the bench screen and computer can provide a substantial cost savings.

In addition to consolidation of stand-alone/bench-top equipment, workbench 100 can also integrate with standard Automatic Test Equipment (ATE). For example, the bench could obtain test data from ATE to use during further troubleshooting/repair. Rather than manually recording test data to be used for repair steps such as “select at test” resistors, this data could be brought directly to the technician at his workstation. Direct control of ATE could be performed in cases where it could be done safely. Obtaining test results would likely be a first step in the process because the ATE software typically generates this data already, so no ATE code changes would be required.

CPU 103 may be programmed with a web browser for distribution of data to workbench 100. Two distribution paradigms are proposed: a push system (XML Viewer) and a pull system (Adobe Acrobat files). Digital technical data for a particular enterprise may be transformed to a common format using the Standard Generalized Markup Language (SGML). The SGML documents will be stored in a central repository and will serve as the “official technical data”, and will reside behind a firewall. This SGML standard will serve as the catalyst for further document transformation into familiar delivery formats such as Adobe Acrobat. SGML records may also be transformed using the Extensible Markup Language (XML) for ease and diversity of usability and interoperability.

In addition, decentralized repositories of technical data may be managed at group levels. The integrity of these repositories will be the responsibility of local management. These decentralized repositories can refer to the “official technical data” but can additionally allow such shop-specific technical data as process orders, work control documents, and expert knowledge assets to be stored.

The desktop configuration programmed into CPU 103 can provide at least two alternatives: (1) icons on an existing desktop view, or (2) a proprietary toolbox desktop.

The first option will simply populate the existing computer desktop with icons for all desired applications and resources. Benefits of this system are that it is low cost; can be updated organically, and is already known by shop personnel.

The toolbox option organizes each application by category (e.g., training, forms, applications, publications, etc.). This option will be a custom-built application which will open automatically as the user logs into the computer. It will be populated dynamically based on the user log-in. The Desktop Maintenance Toolbox™ allows for personalization of required resources based on users. It will be managed by shop supervisors or other designated government personnel. Benefits of the toolbox option include efficiency in locating items based on categories, ease of on-demand reconfiguration, flexibility for future modifications, user-friendly “clutter-free” desktop.

What is claimed is:

1. A digital workbench, comprising:
a table having a retractable side drawer;
a frame affixed to the rear edge of the table and extending vertically from the rear edge of the table;
a first monitor attached to the frame;
a second monitor housed in the side drawer;
a keyboard;
a keyboard shelf under the table surface;
a track ball input device (mouse); and
a camera mounted on one end of an articulated adjustable arm;
wherein the other end of the arm is affixed to the frame;
a bar code scanner mounted to the frame; and
an overhead light source attached to the frame operable to light the surface of the table, and vertically adjustable up and down the frame, and adjustable such that the angle of light incident on the surface of the table can be changed; and
a processing unit in data communication with the first monitor, the second monitor, the keyboard, the trackball device, the camera, and the bar code scanner.
